(19) United States
(12) Patent Application Publication
(10) Pub. No.: US 2017/0061486 A1
(43) Pub. Date: Mar. 2, 2017

(54) Method and system for managed promotional advertising

(71) Applicant: Jie Cheng, Hayward, CA (US)

(72) Inventors: Jie Cheng, Hayward, CA (US); Haifeng Chen, Hayward, CA (US)

(21) Appl. No.: 14/839,962

(22) Filed: Aug. 29, 2015

(51) Int. Cl. G06Q 30/02

(52) U.S. Cl. CPC G06Q 30/0257; G06Q 30/0275; G06Q 30/0214

(57) ABSTRACT

Techniques related to data communication between a server device and a client device are described. In one aspect of the present invention, a server device is operated by an advertiser or an ad publisher in connection with a plurality of advertisers, and the client device is a computing device associated with a consumer or an end user. Depending on what information submitted from the client device, the ad publisher determines most relevant advertisements to the end user and compensates the end user for one or more of the advertisements. According to one aspect of the present invention, the server device executes a server module created, uniquely designed, implemented or configured to cause the server device to determine what are the most relevant advertisements a subscriber is interested in viewing at a cost most effective to the publisher/advertisers of the advertisements and a payment most appealing to the user.

### BACKGROUND OF THE INVENTION

Field of the Invention

The present invention is generally related to the area of data communication between a client and a server over the Internet. Particularly, the present invention is related to techniques for communications between a business entity and an end user, wherein the business entity desires to send messages to the end user who gets compensated for viewing the messages (e.g., a text, an alert or an advertisement). The present invention is also related to techniques for determining a business entity among others to reach an agreement with an end user to receive such messages therefrom based on certain criteria. Depending on the constraints imposed by the user, promotional messages can be delivered efficiently and usefully, effectively catching the eyes of users expressing an interest in goods/services in the messages and reaching a result that a traditional advertising campaign would never match.

Description of the Related Art

The advertisement industry penetrates every aspect of our life. Traditional advertising channels including newspapers, radio, and television offer a variety of products that can be tailored to virtually any market and satisfy companies of any size. However, they can only provide static content and cannot engage potential customers interactively. Rapid growth of the Internet offers the advertisers a unique opportunity to make interactive advertisement campaigns possible by allowing end users to close the loop, namely inducing users to click on an advertisement being served or linking the users to the actual product or service being advertised.

One early form of advertising over the Internet is the “banner ad,” which entails embedding an advertisement into a web page. The banner ad is intended to attract traffic to a website of the advertiser. The advertisement (ad) is typically constructed from a high aspect-ratio image, often employing colors, animation or sound to maximize its presence in a webpage. These types of advertisements can be positioned somewhere near the primary content in the webpage (e.g., from a newspaper article or a collection of web portal links). The typical banner ad is purchased in bulk by an advertiser from a publisher of the webpage, hence content publisher. Often, the content of the advertising bears no relationship to the interests of the viewer, and therefore makes it unlikely that the viewer may attempt to click through to the website of the advertiser. For example, it is very unlikely that male users would click through any banner ads that show cosmetic promotions for females.

It is reported that online video ads are getting three times more clicks on average than other digital ad formats, including mobile, display, and rich media ads. That performance is attracting advertisers to digital video, and helps to explain why it is growing faster than most other ad formats. However, video ads have an average click-through rate (CTR) of 1.84%. One of the reasons behind this low CTR is that very few users have the patience to watch through a video advertisement if the subject of the video ad is not substantially interesting to the viewer. Many publishers, such as Youtube, force a viewer to watch some video ads before, during or after a selected video program. Most users, if not all, would click “Skip Ad” to go right into their selected videos. Thus there is a great need for delivering ads efficiently and usefully.

There are two dominant techniques in on-line marketing today. The first one is contextual-based; an advertisement being served is chosen based on the browsing context. In other words, an ad being delivered to an end user is based on the content of a web site being visited. For example, users going to a car site, such as “Edmund's car buying guide”, will most likely be presented with an automotive advertisement displaying a car or related accessories and services. The second one is behavioral based; an advertisement being served is chosen based on the previous browsing history of a user and is not necessarily related to the content of a site currently being viewed.

A business that knows exactly what website a user is visiting and all activities the user has been conducting on the Internet is the one that owns the networks and various mechanisms to facilitate users to access the Internet. The business is commonly referred to as “service provider”. In various ways, a service provider facilitates movement of packetized information in a computer network. From one perspective, service providers possess the first-hand information of all the packets traveling on their networks. However, such a service provider is not legally allowed in US to deliver ads using the first-hand knowledge of their subscribers.

The well-known website www.google.com is not a network-access service provider per se and is one of the examples based on context. For example, when a user enters a search query on the website, the website delivers advertisements based on the search terms in addition to delivering the requested content responding to the search query. In this case, the content provider (i.e., the search engine website) is the intended recipient of the search query from the user, so the content provider is able to provide targeted advertising based on the search query or the results from the relevant search websites. Thus, the content provider possesses the information necessary to make determinations regarding the content and context from the user.

Nearly all the digital ads (e.g., email, banners or videos) are delivered by publishers or content providers. They are the middlemen between advertisers and the consumers. Most of the advertising costs are squarely spent with the publishers or content providers. In today's rapid media-consumption world, every millisecond matters in ad delivery. If a middleman does not deliver an ad fast enough to a relevant consumer or deliver the ad wrongly, there is a chance that the ad would never be presented at all to the relevant consumer. There is another need for mechanisms that bridge advertisers and end users so that every ad is delivered correctly and usefully.

Reading or viewing several ads a day consumes time. Not every end users are willing to do so even if every ad may appear interesting. However, the situation would be different if an end user is compensated for viewing ads relevant to his/her interests. There is still another need for mechanisms that compensate recipients for reviewing their interested ads. Other needs shall become apparent upon examining the following detailed description of the present invention.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to data communication between a server device and a client device. The server is operated by an advertiser or an ad publisher in connection with a plurality of advertisers, and the client device is a computing device associated with a consumer or an end user. Depending on what information submitted from the client device, the ad publisher determines most relevant information to the client device and compensates the end user for viewing, and/or responding to, and/or performing an intended action after viewing the information (a.k.a., ad incentive service or ad reward service). According to one aspect of the present invention, the server device executes a server module invented, uniquely designed, implemented or configured to cause the server device to determine what is the most relevant information a subscriber is interested in viewing, at a cost most effective to the publisher/advertiser of the information, and a payment that is feasible and most appealing to the user.

According to another aspect of the present invention, a process is invented, uniquely designed, implemented or configured to conduct a bidding process among a plurality of advertisers to accommodate a user willing to view relevant messages for a mutually agreed pay rate. The process is able to automatically adjust a pay rate for other relevant ads whenever there is a report of a click-through on one ad by a user. The pay rate may be significantly adjusted whenever there is a transaction related to an item (goods or service). In addition, the process can automatically add an additional incentive should the user forward an ad to one of his/her contacts that ends up with subscribing to the viewing ad incentive service, clicking through one or more ads or conducting a transaction.

According to still another aspect of the present invention, a process is invented, uniquely designed, implemented or configured to allocate relevant ads in accordance with a profile of a user and preferences provided by the user. The process is able to allocate additional ads related to items that may expand or supplement the use/consumption of a purchased item promoted in a viewed ad.

According to still another aspect of the present invention, a mechanism is invented, uniquely designed, implemented or configured to allow a user who has agreed to view ads for pay to add or delete one or more advertisers per his/her own wishes. The mechanism may also be used to allow the user to configure when, where or how the ads may be present for viewing.

According to still another aspect of the present invention, payments for viewing ads may be made individually or collectively to an account specified by a user. Depending on the implementation or advertisers, the payment may be in the form of cash, reward points, voucher, discounts or other incentives and used when a purchase is made.

According to yet another aspect of the present invention, a user maintains an electronic wallet with a mobile device. The payment may be made directly to the wallet. The balance in the wallet may be used whenever a mobile payment is applied.

The present invention may be implemented in software or in a combination of software and hardware, and practiced as a system, a process, or a method. According to one embodiment, the present invention is a method for compensating a user for viewing a message, the method comprises: establishing in a server device an account for the user; receiving in the server device a profile including a set of preferences defined by the user, wherein the profile is supplied from a client device associated with the user; determining how, when and where, authorized by the user, to show the message to the user on the client device, wherein the user is compensated for viewing the message; allocating a set of messages from providers in accordance with the profile and internal data, wherein the internal data (e.g., user behavior data) is collected over time about the user; conducting a bidding process among the providers to determine a queue of showing the messages selectively, wherein each of the messages in the queue has a pay rate to the user when the user views the each of the messages; presenting the messages in the queue when an opportunity presents; and monitoring how the user views each of the messages.

According to another embodiment, the present invention is a mobile device for compensating a user for viewing a message, the mobile device comprises: a display screen; a memory space for storing a client module; a processor, coupled to the memory space, executing the client module to cause the mobile device perform operations of: receiving a profile including a set of preferences defined by the user; receiving instructions from the user as to how, when and where to show the message to the user on the display screen, wherein the user is compensated for viewing the message; receiving a set of messages from a server in accordance with the profile and internal data, wherein the internal data is collected over time about the user, the message is determined by conducting a bidding process among the providers to determine a queue of showing the messages selectively, wherein each of the messages in the queue has a pay rate to the user when the user views the each of the messages on the display screen; presenting the messages in the queue when an opportunity presents; and monitoring how the user views each of the messages.

According to still another embodiment, the present invention is a method for rewarding a user for receiving a plurality of advertisements, the method comprises: allocating the advertisements in a server device in accordance with a profile of the user; determining by a server module being executed in the server device a set of opportunities as to how, when and where, authorized by the user, to deliver the advertisements to a client device associated with the user, wherein the opportunities are automatically captured on the client device and the user is compensated for viewing or listening to the advertisements; conducting a bidding process among advertisers to determine a queue of delivering the advertisements selectively, wherein each of the advertisements in the queue has a pay rate to the user when the user views or listens to the each of the advertisements; presenting the advertisements in the queue when an opportunity presents on the client device; monitoring how the user views each of the messages; and updating the profile whenever there is an interaction with one of the advertisements by the user. Depending on implementation, the bidding process further includes a conditional bidding process to allow an advertiser to place an additional advertisement after a successful transaction by the user with one of the advertisements.

According to yet another embodiment, the present invention is a mobile device for rewarding a user for receiving a plurality of advertisements, the mobile device comprises a display screen; a memory space for storing a client module; a processor, coupled to the memory space, executing the client module to cause the mobile device perform operations of: allocating the advertisements in a server device in accordance with a profile of the user; determining by a server module being executed in the server device a set of opportunities as to how, when and where, authorized by the user, to deliver the advertisements to a client device associated with the user, wherein the opportunities are automatically captured on the client device and the user is compensated for viewing or listening to the advertisements; conducting a bidding process among advertisers to determine a queue of delivering the advertisements selectively, wherein each of the advertisements in the queue has a pay rate to the user when the user views or listens to the each of the advertisements; presenting the advertisements in the queue when an opportunity presents on the client device; monitoring how the user views each of the messages; and updating the profile whenever there is an interaction with one of the advertisements by the user.

One of the objects, features, and advantages of the present invention is to cause a server device to determine what is the most relevant information a subscriber is interested in viewing at a cost most effective to the publisher/advertiser of the information and a payment most appealing to the subscriber.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A shows a basic system configuration in which the present invention may be practiced in accordance with one embodiment thereof;

FIG. 1B, it illustrates an internal functional block diagram of a mobile device that may be used as a client device in FIG. 1A;

FIG. 2A shows a logic relationship between a client and a server, where the client represents one of many clients that are intended to communicate with the server;

FIG. 2B.1 shows a set of exemplary displays that may result from the client module being executed in the mobile device;

FIG. 2B.2 shows an example of providing three windows (slot A, B and C) to show ads related to food and drinks to a user;

FIG. 2C shows that an ad publisher may cooperate with a content publisher to place the relevant ads in lieu of the ads selected or placed by the content publisher;

FIG. 2D shows an example in which a user in US is accessing a website operated by a Chinese content provider;

FIG. 3A shows a flowchart or process of reaching an agreement with a user to get compensated for viewing one or more ads from one or advertisers;

FIG. 3B shows an example of allocating relevant ads for a user using a device (not shown), where it is assumed that the user has provided a list of his preferences (e.g., discounts/promotions from all local stores near his location, energy drinks and featured products/services in his area) in addition to his desire of buying a flat smart TV in size of 40-45 inches in the next one or two weeks;

FIG. 3C shows two examples of displaying the ads on a mobile device the user is using;

FIG. 3D shows how to report an activity of viewing an ad according to a pre-set of criteria;

FIG. 3E shows an exemplary webpage on a social network to show a forwarded advertisement either on a personal page (a whitewall) or to an appointed contact;

FIG. 4A shows a functional block diagram of a server machine or server in which a server module resides in a memory space and is executable by one or more processors;

FIG. 4B shows a flowchart or process of forming a queue of ads to be shown to a user;

FIG. 4C shows an example of ad opportunity before an application is fully launched; and

FIG. 4D shows an example of lined-up ads for showing when an opportunity presents.

### DETAILED DESCRIPTION OF THE PREFERRED EMBODIMENTS

The detailed description of the present invention is presented largely in terms of procedures, steps, logic blocks, processing, or other symbolic representations that directly or indirectly resemble the operations of data processing devices. These descriptions and representations are typically used by those skilled in the art to most effectively convey the substance of their work to others skilled in the art. Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

The present invention pertains to a system, a method, a platform and an application each of which is invented, uniquely designed, implemented or configured to cause a server device to determine what is the most relevant information a subscriber is interested in viewing at a cost most effective to the publisher/advertiser of the information and a payment most appealing to the user. As used herein, any pronoun references to gender (e.g., he, him, she, her, etc.) are meant to be gender-neutral. Unless otherwise explicitly stated, the use of the pronoun “he”, “his” or “him” hereinafter is only for administrative clarity and convenience. Additionally, any use of the singular or to the plural shall also be construed to refer to the plural or to the singular, respectively, as warranted by the context.

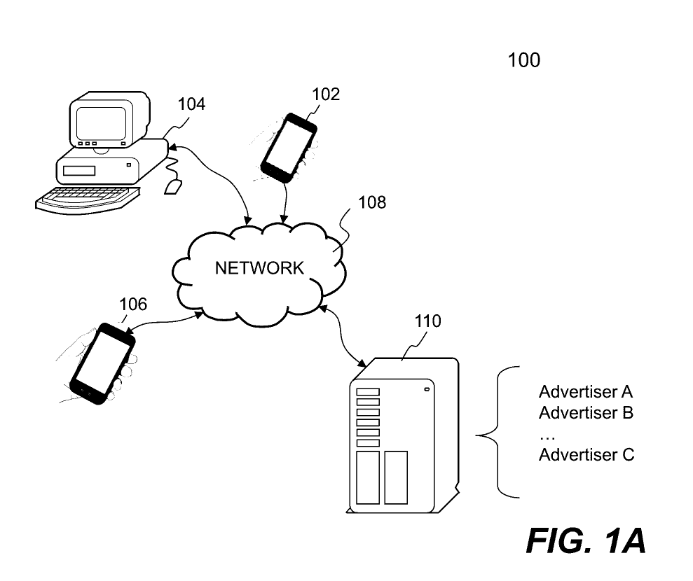

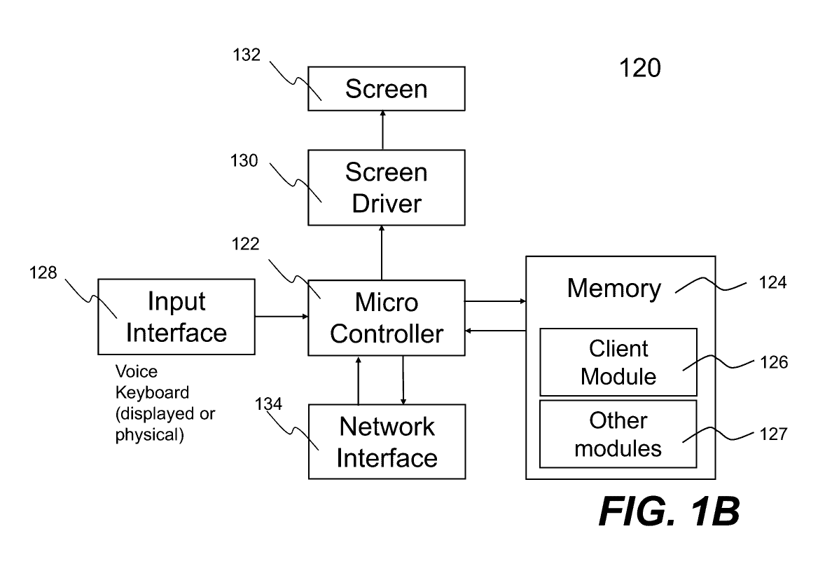

One of the benefits, advantages and objectives in one embodiment of the present invention is to allow an advertiser and a user to reach a mutual agreement for the advertiser to deliver what is interesting to the user while the user sees the advertisement for a monetary reward. Referring now to the drawings, in which like numerals refer to like parts throughout the several views. FIG. 1A shows a basic system configuration 100 in which the present invention may be practiced in accordance with one embodiment thereof. FIG. 1A shows that there are three representative computing devices 102. 104 and 106, where the device 102 or 106 is meant to be a mobile device (e.g., a wearable device, a smart phone, a tablet or a laptop) while the device 104 is meant to represent a stationary device (e.g., a desktop computer). Each of the devices 102, 104 and 106 is loaded with a program, an application or a client module. In particular, Each of the devices 102, 104 and 106 is associated with a user, some of the devices 102, 104 and 106 are preferably to have a touch-screen display, as most of the mobile devices do. Although other man-machine interfaces are possible, a touch-screen display provides the convenience for a user to interact with a presence of a commercial message. It should be noted the presence of an ad herein means that there is an indication of an ad. Depending on the ad, the presence of the ad may require an interaction of the user with it to view the details of the ad. For example, an elongated ad banner or a hypertext with link is considered a presence of the ad. To view the details of the ad, a viewer must interact with it, for example, after a predefined time or a click on it brings up another view of the ad (e.g., a video ad or a website).

It is assumed that the user is interested in the subject of the commercial message (e.g., 2-for-1 lunch deal) and decides to view the commercial message that shows the details (e.g., Time: 11:00 AM-1:00 PM, where: McDonald's 500 yards on the right) on his device (e.g., a mobile phone). The user may forward or refer the message to his contact(s). According to one embodiment, the user may copy a link to the commercial message and paste the link in a message or email to his contact(s). The user may also publish the message in his social network page. As will be described further, the user gets an additional reward added to his profile or account when the forwarded message is eventually viewed or/and clicked through by one of his contacts.

According to one embodiment, a server device 110 is provided to administrate a bidding process between a user and a plurality of publishers or advertisers. In addition, the server device 110 maintains a plurality of accounts, each corresponding to a subscriber, an audience member, a listener, a viewer, a user of mobile device, an advertisee (a person to receive an ad) or an end user (hereinafter “a user” or “the user”) who has expressed his particular interests to view related advertisements for pay. For simplicity, server device and server are interchangeably used hereinafter, so are client and client device. Accordingly, FIG. 1A shows a server executing a server module is in data communication with a plurality of clients, each of the clients executing a client module, where the server module or the client module implements one or more embodiments of the present invention.

Referring now to FIG. 1B, it illustrates an internal functional block diagram 120 of an exemplary mobile device that may be used as a client in FIG. 1A. The mobile device includes a microprocessor or microcontroller 122, a memory space 124 (e.g., RAM or flash memory) in which there is a client module 126, an input interface, a screen driver 130 to drive a display screen 132 and a network interface 134. The client module 126 may be implemented as an application implementing one embodiment of the present invention, and downloadable over a network from a library (e.g., Apple Store) or a designated server.

The input interface 128 includes one or more input mechanisms. A user may use an input mechanism to interact with the device 120 by entering a command to the microcontroller 122. Examples of the input mechanisms include a microphone or mic to receive an audio command and a keyboard (e.g., a displayed soft keyboard) to receive a click or texture command. Another example of an input mechanism is a camera provided to capture a photo or video, where the data for the photo or video is stored in the device for immediate or subsequent use with other module(s) or application(s) 127. The driver 130, coupled to the microcontroller 122, is provided to take instructions therefrom to drive the display screen 132. In one embodiment, the driver 130 is caused to drive the display screen 132 to display an image or images (e.g., an ad banner) or play back a video (e.g., an ad video). The network interface 134 is provided to allow the device 120 to communicate with other devices via a designated medium (e.g., a data network).

According to one implementation, the client module 126 is loaded in the memory 124 and executed by the controller 122 to receive an ad and determine how the user views the displayed ad. As will be further described below, the ad may be simply viewed, interacted with or forwarded to a contact (e.g., spouse, friend). Depending how the ad is viewed, the client module 126 reports back to a server (e.g., the server 110 of FIG. 1A), where a profile of the user is updated. More importantly, the user is paid for viewing the ad. In one embodiment, an account of the user is awarded with a payment as mutually agreed between the user and an advertiser via the publisher running the server.

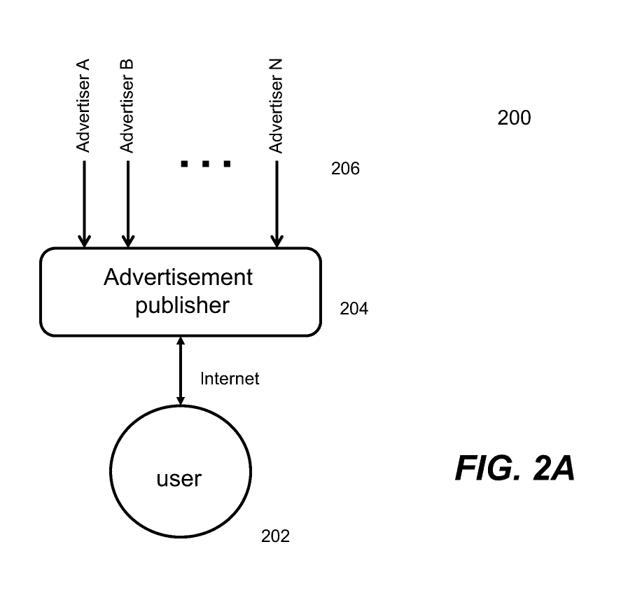

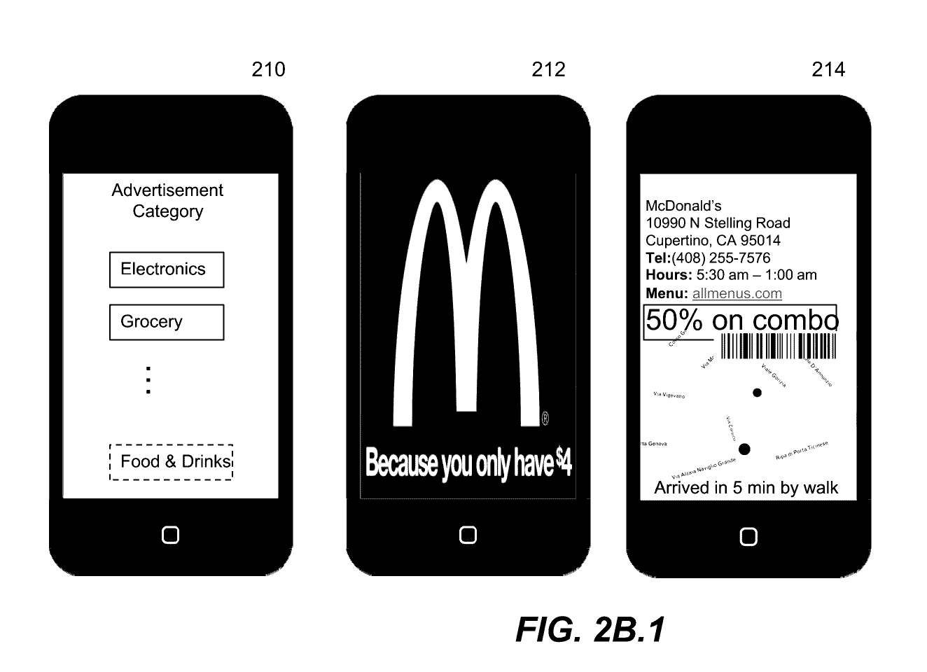

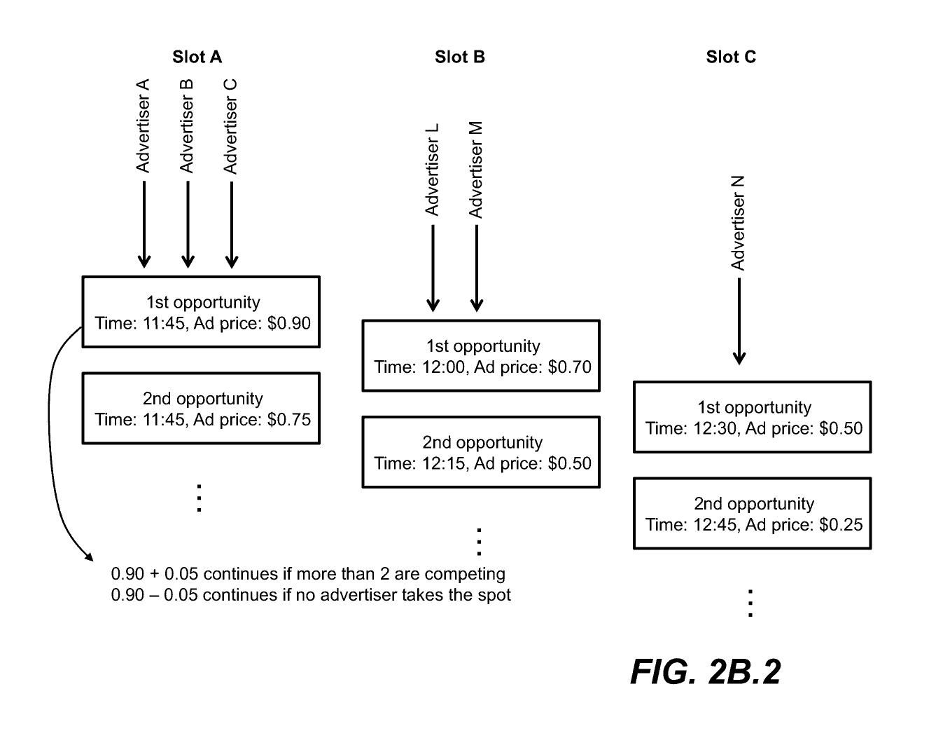

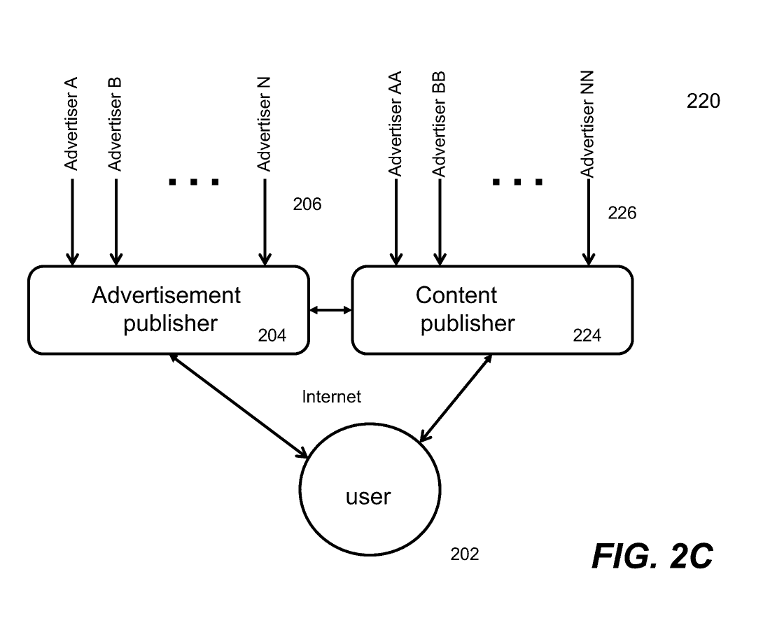

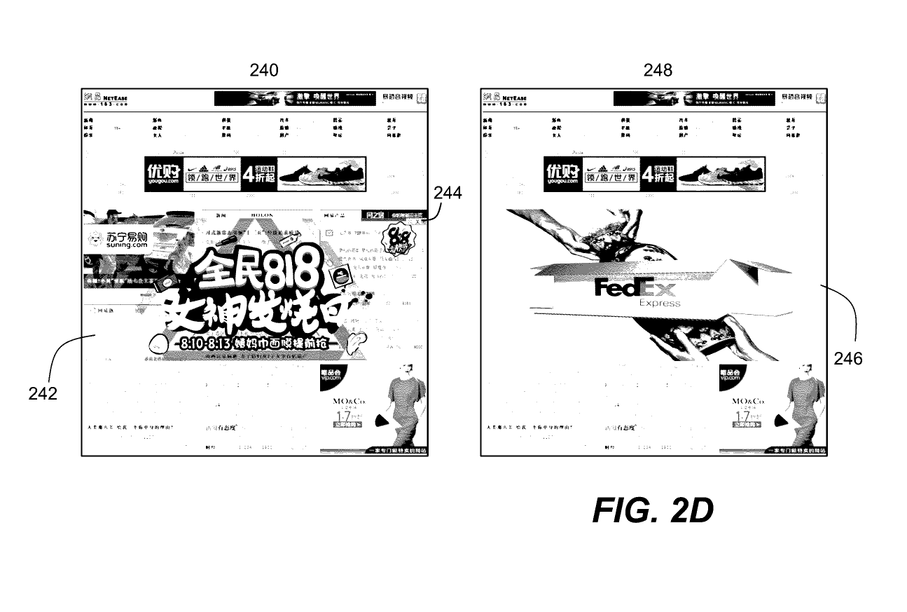

Referring now to FIG. 2A, it shows a logic relationship 200 between a client 202 and a server 204. The client 202 represents one of many clients that are intended to communicate with the server 204. Users of the clients subscribe certain ads they are interested in viewing. In return, they are compensated for viewing the ads from a plurality of advertisers 206 who are willing to pay for viewing their ads or other related actions. According to one embodiment, the ads from the advertisers 206 are distributed via the server 204. A provider or ad publisher operating the server 204 works with the advertisers 206 and is responsible for distributing their ads to the right users on one side, and determines which ads shall be sent to a user at a time or/and in a way opted-in by the user when a set of criteria is met on the other side. One of the key differences between the traditional ads campaign and the current invention is that former distributes ads in digital media to a targeted group of users regardless they view the ads or not (mostly they don't in reality) while the latter distributes ads to those who wanted to see and guarantees that the distributed ads are viewed, inducing much more clicks-through. Although the viewers are compensated for viewing the ads, the advertisers would have saved substantially since each distributed ad hits the right audience and gets viewed. It should be noted that the provider or publisher operating the server 204 can be an advertiser as well. Without departing the principle of the present invention, a large portion of the description herein is based on the embodiments in which an ad publisher is charged for distributing the ads. Those skilled in the art shall appreciate other means of distributing the ads in the similar fashion is possible but all falling in the scope of the present invention.

According to one embodiment, a user interested in viewing ads for pay installs a client module in his device (e.g., a mobile phone, a tablet, a laptop or a desktop computer). When the client module is executed for the first time, the user is required to sign up with the ad reward service that distributes ads in accordance with his interests or preferences. For example, the user has expressed his interest in viewing ads in the areas of electronics, grocery, food and drinks, as a result, he may get a bargain for a large sized OLED TV in his newly remodeled living room, a discount in regular shipping at a local supermarket or a deal for lunch nearby. As will be further detailed below, these ads are sent and viewed by the user for monetary rewards.

FIG. 2B.1 shows a set of exemplary displays that may result from the client module being executed in the mobile device. Based on the interests expressed by the user, the server executing a server module configured to send a set of ads in accordance with the interests. The display 210 shows an exemplary list of ads categories, each holds one or more ads from corresponding advertisers. It may also be used to show a presence of ads, namely the user has not seen the details of each of the ads before an activation happens. It is assumed that a user decides to check out deals in the category of food & drinks before lunch time. He may activate or click on the “Food & Drinks” category that may lead to a show of a list of available ads related to restaurants, special lunch or dinner deals, and drinks at local stores. For example, there are two available ads, one from McDonald's and the other from Pizza Hut, all local to the user at the time of viewing the category. The user may choose one or both to view. In the context of the present invention, these two ads are allocated especially for the user who will be compensated for viewing each of the ads if he chooses to do so.

According to another embodiment, an ad is shown when the user enters the category. The one that shows immediately or first is generally the one that the advertiser thereof is willing to pay the viewer the most. When there are multiple ads that may all fit into the interest of the user, the order of the ads may be arranged based on a pay rate the corresponding advertiser is agreed to pay. A higher pay rate may command an ad to be shown earlier to the user. As will be described below, a bidding process may take place among the advertisers per the user to secure a preferable place or time of their own ads in a queue.

FIG. 2B.2 shows an example of providing three windows (slot A, B and C) to show ads related to food and drinks to a user. The ad publisher auctions the ad positions among a group of advertisers interested in showing their respective deals to the user. Statistically, local lunch ads are most effective when an ad is shown to the user around 11:45 AM since many employees are about to take a lunch break and look for a place to eat. The first opportunity is auctioned for $0.90, which means that the ad for this spot will be displayed to the user around 11:45 AM whenever there is an opportunity to show the ad. For example, the ad is displayed in a corner of a webpage being viewed by the user on a desktop computer or when the user reactivates his mobile phone. Alternatively, an audio alert is played to attract the attention of the user to the ad around 11:45 AM.

When there are more than one advertisers desired to place their ads for this slot, the price to place the ad is incremented till there is only one advertiser left. Similarly, the price to place the ad is decremented till there is one advertiser coming to take the slot. In operation, the rate for all opportunities (e.g., 1st, 2nd, 3rd . . . with different rates) are auctioned at the same time to accommodate different types of advertisers. Since the time for lunch deal is sensitive, the effectiveness of the lunch ads goes away with the time running into the traditional lunch time. The bidding process may also auction different slots at different times. FIG. 2B.2 shows that there are three slots A, B and C, each starts to show the ads at pre-defined times. At time slot A, there are initially three advertisers bidding for the 1st opportunity. As the rate for the first, second and third opportunity increments or decrements, at certain point, the three advertisers are settled with their own ads in three different opportunities. At time slot B, the rate is lower (perhaps many lunch goers have already made their minds), only two advertisers compete for the first and second opportunities to place their ads. Similarly, at certain point, the two advertisers are settled with their own ads in two different opportunities. At time slot B, the rate is even lower (perhaps many lunch goers are almost done with their lunch), the rate for first opportunity is periodically or continuously decremented till there is one advertiser coming to place an ad for a bargain.

According to another embodiment, the bidding process may be expanded to auction an opportunity after a certain action. For example, after an ad is shown to a user and there is a click-through resulting in a successful transaction of an item in the ad, another ad supplementing or expanding the use or consumption of the item may be particularly appealing to the user. Such a supplemental ad opportunity, nevertheless, is conditional per se as it is based on a follow-up action (that may or may not happen) on the previous ad and may also be auctioned among relevant advertisers.

Referring now back to FIG. 2B.1, when an opportunity presents, an ad is shown. If the user is interested in the item being promoted in the ad, he may proceed by clicking it (a click-through happens). If the user is not interested in the ad, he may continue to a next ad. Nevertheless, the ad has been viewed so the user gets compensated. The display 212 is an example either selected from the category by the user or an automatic display based on an order in a queue per an arrangement. It is assumed that the user is interested in the ad and interacts with it to bring up the display 214 to show the location of the place, a corresponding phone number or an electronic coupon (e.g., 1-D or 2-D barcode or symbol) that may be scanned or read when the user uses it at a checkout counter. In one embodiment, the ad or the coupon therein is personalized per the user so that the advertiser/publisher can be electronically notified that the ad has been utilized. In addition, the display 212 may also show an electronic map or activate a map application such as Google Map to show how far it is from where the user is now and the routing direction.

In one embodiment, the client module includes an electronic purse that is credited with a payment from the advertiser for the user to view the ad therefrom. The payment is a reward from the advertiser to the user for viewing the ad. In general, the payment or payment rate is different from one user to another depending on a profile or the behavior history of a user. For example, if the profile indicates that a user thereof seldom eats fast food, an advertiser of fast food would pay far less reward amount to him than another user indicated to eat fast food at least 5 times a week. Likewise, a TV manufacturer or store would pay a much higher reward for its ad to a user currently shopping a TV than a user who is really not in the market for TV.

When a user clicks through a displayed ad, his profile is updated. Depending on the nature of the ad, the reward for viewing the same type of ads may be increased or decreased. In the event as shown in FIG. 2B.1, the user has clicked through the ad and even visited the local McDonald's, the commission to view another McDonald's ad is increased because the advertiser anticipates that it is likely that the user may view a similar ad and click through it again, and eventually utilize the ad. Nevertheless, a TV manufacturer or all advertisers for TVs would pay far less reward or none after the user has viewed a TV ad, clicked through it and eventually utilized the ad because not many consumers would immediately buy another TV right after having purchased one.

The above description is not limited to viewing an ad in an ad application to host a group of allocated ads. Depending on the arrangement between the user 202 and the publisher 204, an ad may be displayed in an event (i.e., an opportunity to show an ad) that may include, but may not be limited to, at activation time, at wake-up time, or on a lock-screen. The activation time means a moment before an application starts. The wake-up time is a moment a device (especially a mobile phone) is reactivated after it has been in a sleeping mode. The lock-screen is a moment that a device is locked-up for no action before it goes to the sleeping mode. In one embodiment, any of the moments may be used to display one or more ads opted-in by the user. The reward to be paid by an advertiser to a user may vary depending on where, how and when an ad is shown. The reward to be paid by an advertiser to the user may also vary depending on the form of the ad being a banner, a text, a multimedia (e.g., audio or/and video) and a size or length thereof.

According to another embodiment as shown in FIG. 2C, the ad publisher 204 may cooperate with a content publisher 224 to place the relevant ads in lieu of the ads selected by the content publisher 224. In operation, a content publisher gets a bulk of ads from a plurality of advertisers 226 or an ad network. When a user browses a website operated by the content publisher, such as www.yahoo.com, the content publisher relies upon stored cookies or keywords to place some ads in the pages being visited by the user, hoping the user may click on one of the ads. However in reality, very few of these ads are being seen or activated by the user. In one embodiment, the ad publisher 204 works with the content publisher 224 to place its user-oriented ads where the content publisher 224 is planning to place their ads. As a result, the ads are likely viewed by the user as the user is paid to view the ads. On the other end, the content publisher 224 receives a percentage of fee paid by an advertiser to the ad publisher 204.

FIG. 2D shows an example in which a user in US is accessing a website operated by a Chinese content provider. An initial webpage 240 is being displayed with an originally intended ad 242, wherein the ad 242 is to be placed by the Chinese content provider. However, the ad 242 would make not much sense to the user in US since it is related to a superstore in China. Operationally, the delivery of such an ad is inefficient or simply wasted, very likely the user would click at the closure 244 of the ad 242. In one embodiment, the ad 242 is replaced by an ad 246 as shown in the webpage 248, where the ad 246 is selected from a group of allocated ads for the user. Without any implied limitation, the ad 246 is shown as a presence of an ad as well as a showing of the ad since the ad itself shows all the details. Thus the user may be compensated for viewing the ad.

On a mobile device, the display of an image-based ad on a webpage is relatively small compared to the same displayed on a desktop computer. Thus when such an ad is displayed, it is considered as a presence of an ad according to one embodiment. A registered user is typically not compensated for the presence of an ad. When the user intends to zoom into the ad or click it to enlarge the size of the display, the viewing of the ad takes place, thus the user is compensated for viewing the ad.

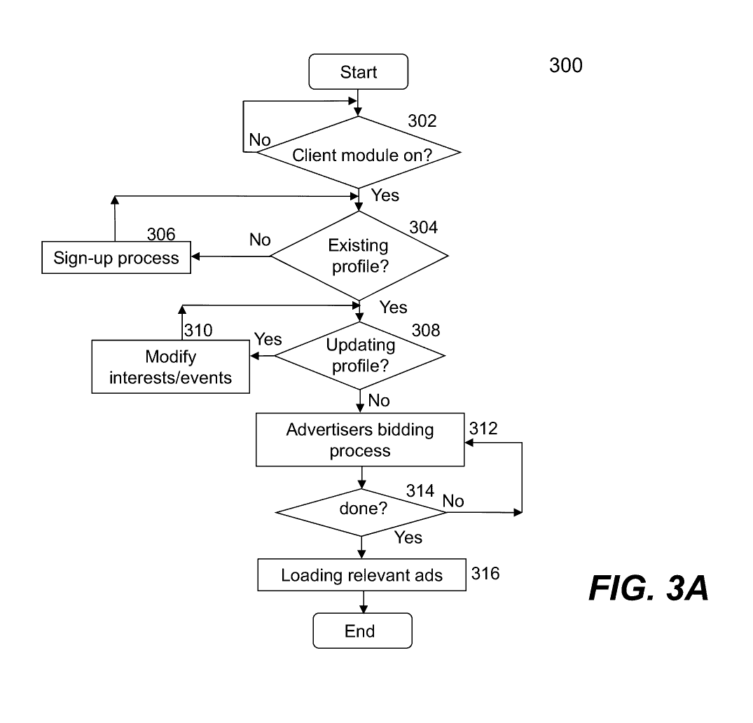

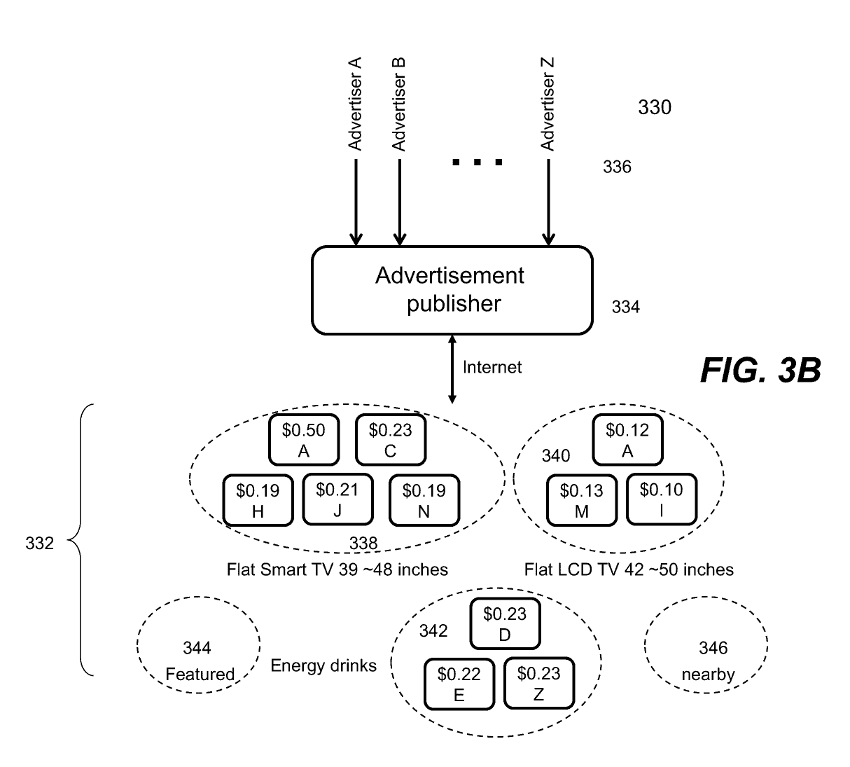

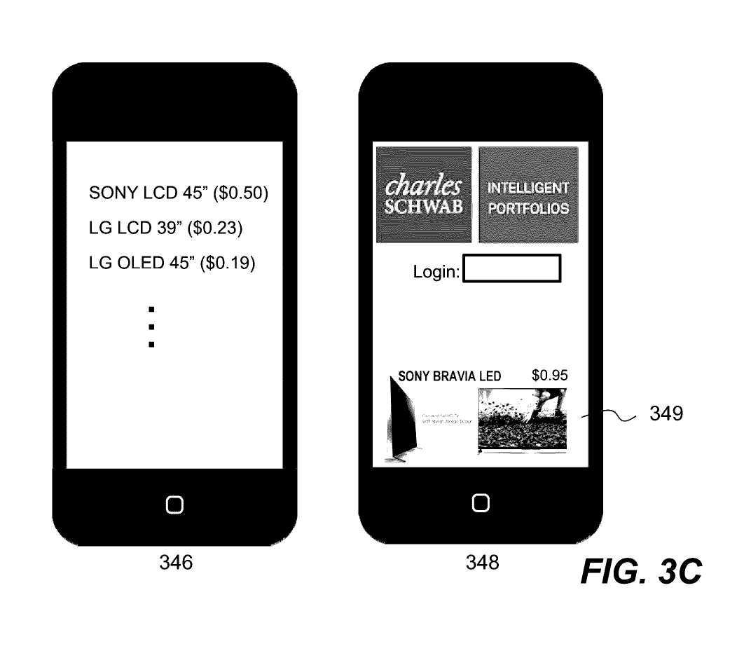

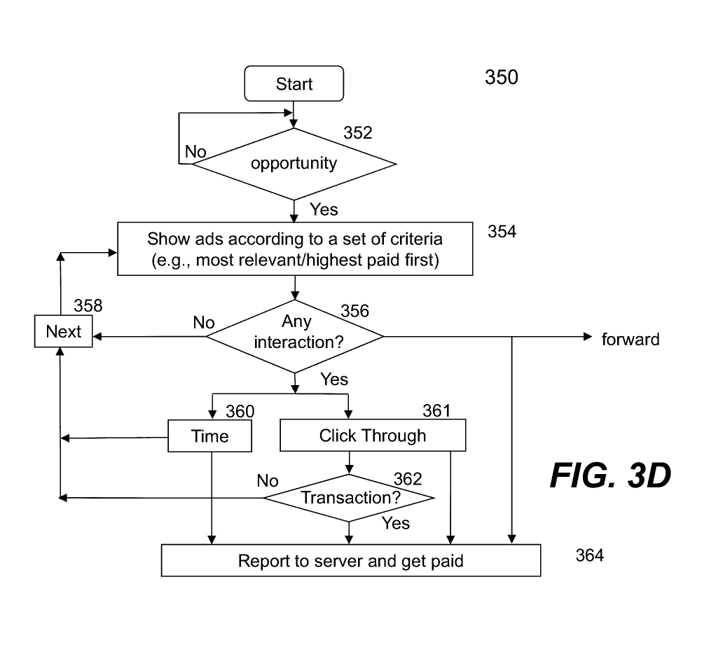

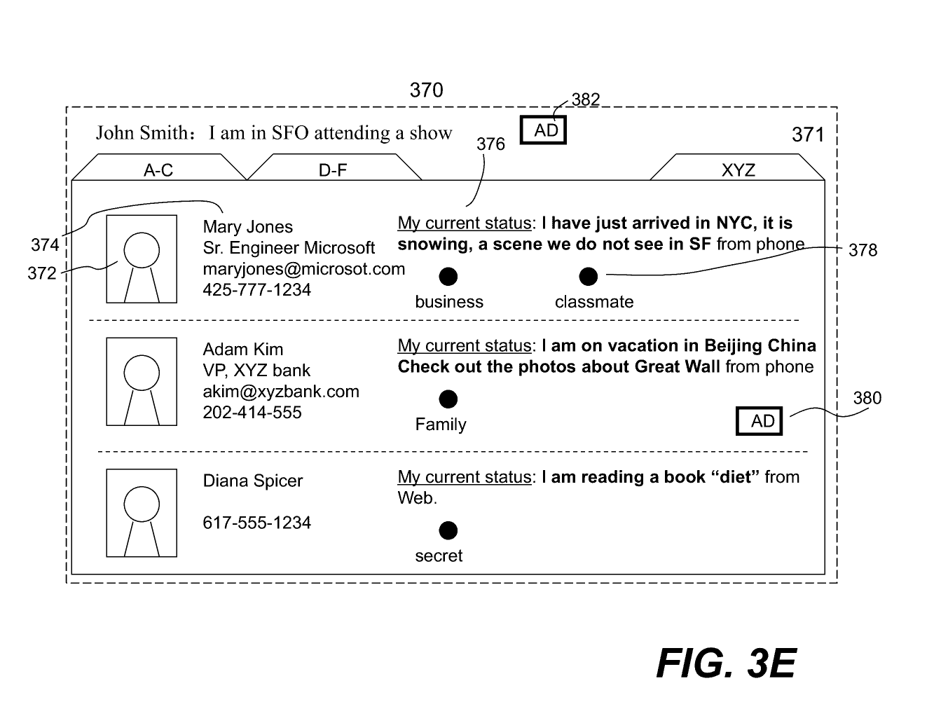

Referring now to FIGS. 3A and 3D, one shows a flowchart or process 300 of reaching an agreement with a user to get compensated for viewing one or more ads from one or more advertisers, the other shows how to report an activity of viewing an ad according to a pre-set of criteria. As will be appreciated by those skilled in the art that the process 300 or 350 is not something a general computer is capable of performing by itself. A general computer must be specifically programmed or installed with a specifically designed module according to one embodiment of the present invention. As will be further demonstrated, the process 300 or 350 undertaken between two computing devices (e.g., a server and a client) is not a collection of human activities as it is practically impossible by any measure for some of the procedures to be performed by or to involve the intervention of human beings. With the execution of a client module or a server module implementing one embodiment of the present invention, the two computing devices are caused to perform beyond what they are originally capable of or meant to do. Each of the processes 300 and 350 may be understood in conjunction with the preceding drawings. Each of the processes 300 and 350 may be implemented in software or a combination of software and hardware.

It is assumed that a user is using a client (e.g., a smartphone or a computer) that has been installed a client module (e.g., the module 126 of FIG. 1B). The module is activated manually or automatically upon an event. At 302, the process 300 can proceed when the module is running. Depending on situation, the user may manually activate the client module by clicking on an icon or link representing the client module or the client module is automatically activated by an application, a webpage being visited, a stored cookie or at a specific time.

The process 300 proceeds to 304 where a profile is examined. If it is the first time the user uses the process 300, the user will be directed to 306, where the user is requested to complete a sign-up process. Depending on implementation, the sign-up process may require some or all of the following: real name of the user, residential address, email address, hobbies, what kind of ads interested to view, an account where a credit or points can be settled with. In addition, there may be a question of what the user is planning to buy immediately, in a week or a month or so. The question may be supplemented with questions of any preferred brand, model, size, color, quantity, or price range, and etc. In one embodiment, the user is asked if the opted-in ads can be placed before, during or after an event (e.g., an application, a visit to a website, in a lock-up screen or activation screen). If the user has already established an account with an ad publisher or provider via a server (e.g., on the server 110 of FIG. 1A), the process 300 goes to 308 to check if the user needs to update his account and/or profile. The procedure 308 may not appear every time but assist the ad publisher to better serve the user with more relevant ads in his interests. Sometimes, the user has purchased something somewhere else while the profile still indicates that the user is planning to purchase the item, in which case sending ads pertaining to the item would be no longer effective. Should the user prefer to modify the profile, the process 300 brings the user to 310, where the user is able to list his latest hopefuls or update with any changes to his account and etc. Once there is no more updates to the profile at 308, the process 300 goes to 312 to start what is referred to as a bidding process.

As described above, a user is compensated for viewing an ad. From the perspective of an advertiser, an ad is delivered to a user who has expressed an interest in viewing it, which significantly increases the chance of a click-through. It should be noted that a click-through is defined as a process of a visitor clicking on an ad and going to another place referenced in the ad (typically a website of the advertiser). The click-through rate measures the amount of times an ad is clicked versus the amount of times it is viewed. One of the purposes of the bidding process is to ensure that an ad publisher and the user reach an agreement that the publisher is authorized to send various ads in accordance with the expressed interests of the user and the user will view them for a pay.

According to one embodiment, a user is requested to list his preferences. For example, the user is interested in seeing ads in the areas of electronics (or more specifically LCD TVs in 30-40 inches) and meal deals for lunch. Thus the ad publisher allocates ads relevant to the preferences and causes these ads to be loaded into the device the user is associated with. With the loaded ads, they can be selectively shown when the device is offline. When the device is online, either stored ads or ads from a server may be shown. Further in the cases of using mobile devices, the pre-loaded ads can be shown at various moments. FIG. 3B shows an example 330 of allocating relevant ads 332 for a user using a device (not shown). It is assumed that the user has provided a list of his preferences (e.g., discounts/promotions from all local stores near his location, energy drinks and featured products/services in his area) in addition to his desire of buying a flat smart TV in size of 40-45 inches in the next one or two weeks. The publisher 334 works with a plurality of advertisers 336 (e.g., advertisers A . . . advertiser Z). In accordance with the listed preferences of the user, the publisher 334 allocates a group of ads 332. It shall be noted that it may appears that the publisher 334 has to work with the advertisers and manually allocates the ads 332 for the user, but the allocation of the ads is actually done automatically without much intervention of human activities. In one embodiment, the server operated by the publisher 334 executes a server module that is invented, uniquely designed, implemented and configured to dynamically allocate the ads 332 given a set of criteria per the listed preferences for each of its registered users.

For example, some of the ads in the ad group 332 may not be there or automatically excluded at a certain point. For example, all ads related to lunch deals in the featured ad 344 are excluded (e.g., replaced or not for showing) when it comes to late afternoon or dinner time. Likewise, all promotions related to winter clothes in the nearby ad category 336 are excluded when the user travels from Boston to San Francisco in the month of October. Further, some or all of the ads in 332 may be stored in local storage of the client or provided online when the client is connected to the Internet. In other words, when the client is offline, the client module being executed in the client is activated to retrieve the stored ads to show when there is an opportunity. As described above and further below, an opportunity for showing an ad can be a moment opted-in by the user, for example, before, during or after an application, ad insertions in a visited webpage or appearing on a lock-up or idle screen, and etc.

Given the preferences provided or updated periodically by the user, mutual agreements are reached via the publisher 334 between the advertisers and the user, where the advertisers are those willing to compensate the user for viewing their ads. Since the user has expressed a desire to buy a flat smart TV in size of 40-45 inches in the next one or two weeks, the advertisers of the TV are offering relatively a higher rate to reward the user to view their ads. In one case, one of the advertisers is offering a TV almost exactly matching what the user may be looking for, in which case the pay rate by the advertiser may be even higher (to attract the user to view it) or sometimes lower (the user is believed to get into the deal anyway). As an example, the ad group 332 shows some ads 338 for flat smart TV 39-48 inches (covering the range specified by the user). Some of the ads in the group 338 for TVs are substantially similar to what the user is looking for, others may be slightly off, different ads offer different pay rate, hopping the user may eventually end up with their products.

As described above, the ads (or categories) 342, 344, and 346 are allocated for a user based on the updated profile or preferences of the user. According to another embodiment, the ads (or categories) 342, 344, and 346 may be determined based on data pertaining to historical activities. When the user interacts with applications, websites or displayed ads, the activities can be captured as data. Further, the locations of the user, where or when he normally goes, when the user wakes up his mobile, the first thing he normally does, even when he charges his mobile device or alters the audio or brightness of the display screen, and how many rings he picks up an incoming call and etc, all can be captured as data. When all sorts of data about the user are gathered together in a server, the data is processed in an effort to identify patterns and associations so that relevant ads can be allocated to effectively induce the user to click through some or all of the ads.

FIG. 3C shows two examples of displaying the ads on a mobile device the user is using. The display 346 shows that there are a number of relevant ads, each showing a different TV with a pay rate in which the user may be interested. It is an example of an agreement between the advertiser and the user. The user may view some or all of these allocated ads for the listed reward. In one embodiment, the pay rate or the order of the ads is dynamically changed subject to, for example, an action from the user to a viewed ad. For example, when the user views the first ad in the display 346 and does not do anything (no click-through), the server module is notified and configured to adjust a couple of ads up in the order as well as in the pay rate in a belief that the user may be interested in a smaller size or a different LCD TV. In any case, the allocated ads may also be shown in another opportunity as shown in the display 348 in which there is a relatively large space to insert or overplay a relevant ad 349 from the allocation 332. As an example, the ad 349 may also include a pay rate for the user to know how much he will be awarded if he activates the ad to view the details thereof.

According to one embodiment, the publisher 334 is configured to add less relevant ads based on the expressed desire from the user. Instead of completely not showing any ads related to non-smart flat TV, the publisher 334 may also allocate some ads 340 related to regular flat TVs, even in a broader size range as some consumers may change their minds when they see a great deal of something that is not exactly what they originally wanted.

Referring now back to FIG. 3A, besides the pay rate determined by the respective advertisers, the publisher 312 may also initiate a bidding process among the advertisers with reference to the user. Given the case that the user has expressed his desire to buy a flat TV in the next one or two weeks, TV manufacturers, stores or distributors would like to get the user to view their own promotions and may compete for the user. For example, one offers one pay rate for viewing its ad, and another offers another pay rate for viewing its ad. With all the considerations including other allocated ads (e.g., the categories 340, 342, 344, and 346), depending on implementation, the publisher 334 decides how, when and where to present an ad in the best interest to its own business, an advertiser or the user.

FIG. 3D shows how to report an activity of viewing an ad according to a predetermined set of criteria. The process 350 starts when there is an opportunity to present a selected ad at 354. Regardless where, when and how an ad is presented on a display of a client being used by a user, the user can see the presence of an ad or view the ad directly. The ad may come in as a banner in graphics or text or in video, awaiting the user to interact with it to show the details of the ad. In the case of an ad being stationary (e.g. a banner or a message), a click on it shall bring the user to a more detailed ad or right to a site (e.g., a specific website or webpage showing the item or service being promoted). In the case of a video ad, the video is automatically played back but allows the user to interact with it anytime during the video. A click on it shall bring the user to a specific website or webpage showing the item or service being promoted.

While an ad is being shown, the process 350 at 356 determines if a displayed ad has been interacted with. After a certain period (e.g., 2 seconds), the process 350 goes to 354 to display a next ad via 358. When the user interacts with a displayed ad, the client module is designed to monitor the process of viewing the ad by the user. In one embodiment, it measures at 360 how long the user has viewed the ad before clicking it and how long the user viewed a website referenced by the ad. The time is captured and reported to the publisher (the server) that may update the profile of the user to facilitate the allocation of ads therefor. It may also monitor at 361 how the user views the site (e.g., navigating through some sizes, colors or others before entering a quantity). If the user quits after viewing the site or before completing a transaction, the behavior or activity is captured and reported at 364 to the publisher. Should the user enter a transaction with the site at 362, the client module captures the transaction (not necessarily the details of what the user has purchased) at 364.

Referring back to 356, when viewing an ad, the user may want to forward or refer the ad to his contact(s). According to one embodiment, a link to the ad is provided, the user may copy the link to the ad and paste it in a message or email to his contact(s). The user may also publish the message in his social network page. Any of the forwarding actions may be reported to the publisher via 364. Depending on implementation, the user may be awarded an additional incentive to do so or even when the forwarded ad is viewed by his contact(s), his contact(s) decided to sign up with the ad reward service or his contact(s) is ended up with purchasing an item being promoted in the ad.

FIG. 3E shows an exemplary webpage on a social network, where a user maintains his own pages, one of which 370 shows a list 371 of contacts established by the user. The list 300 shows three entries or contacts, each showing a photo or a cartoon FIG. 372, a brief indicator 374 of a contact, a status quote 376 and a relationship classifier(s) 378. According to one embodiment, when a user is ready to sign up for the ad reward service, the user may use his username/password of his account on the social network to establish his account for the ad reward service. As a result, the client module is able to access his personal page on the social network. Whenever the user desires to share an ad he believes that may benefit or be of interest to his friends, he can simply forward the ad to his contact(s) on the social network. The webpage 370 shows that the user has forwarded an ad to one of his contacts named “Adam Kim”, where the shared ad 380 shall be accessible or viewable by Adam when Adam logs in. Alternatively, the user may simply post the ad 382 on his personal page, any of his contacts visiting his personal page shall see the ad 382. As described above, should one of the contacts view the ad 380 or 382, the user may be awarded with an extra payment.

According to one embodiment, when a non-registered (new) user wishes to view the details of an ad (e.g., to play back a video ad), the new user is required to sign up for the ad reward service. The new user may also download a copy of the client module into his mobile device from which the sign-up process may be started. By allowing a registered user to forward an ad to a new user, the ad reward service can be populated with more users, thus advertisers can have a large audience to receive their ads. In the contest of the present invention, the ads are directly reaching the eyes of consumers who have expressed certain interests in items being promoted in the ads, resulting in the most efficient delivery of the ads.

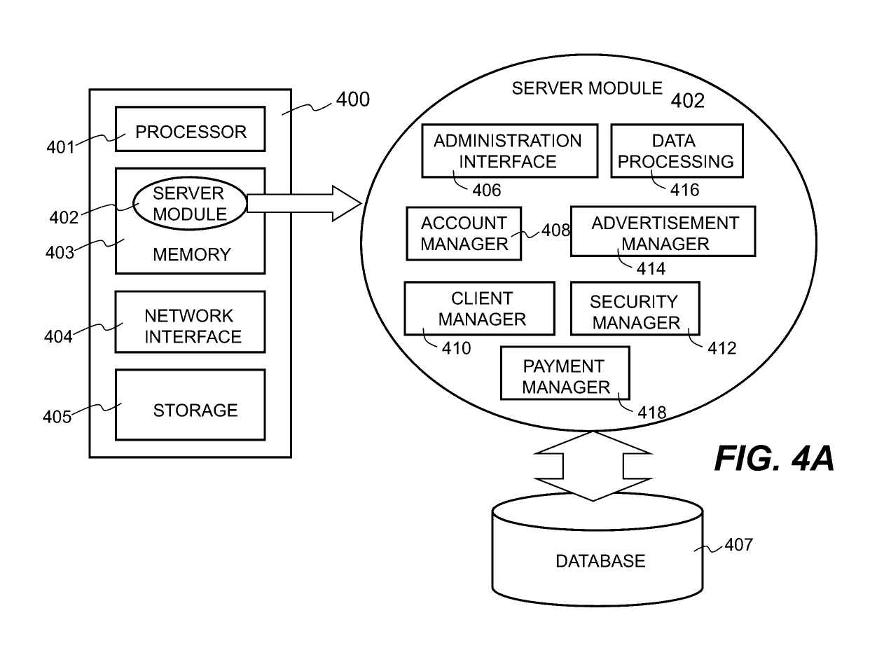

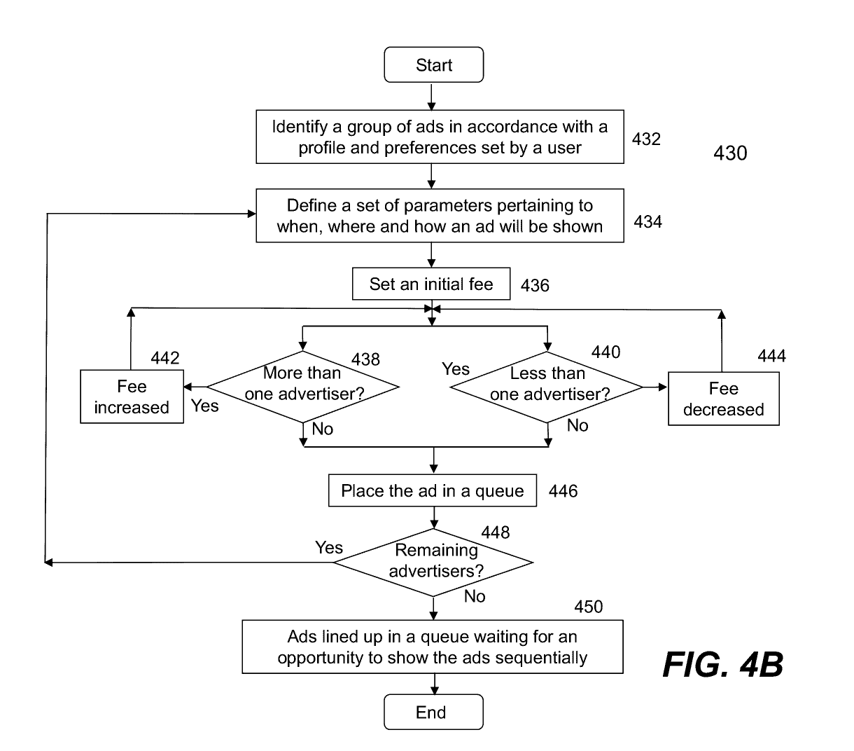

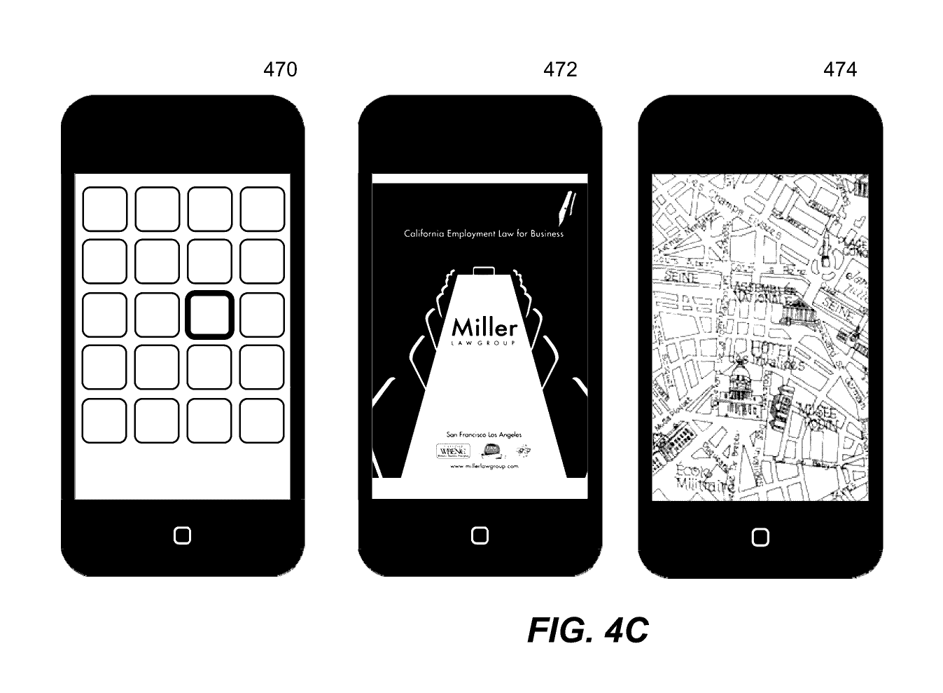

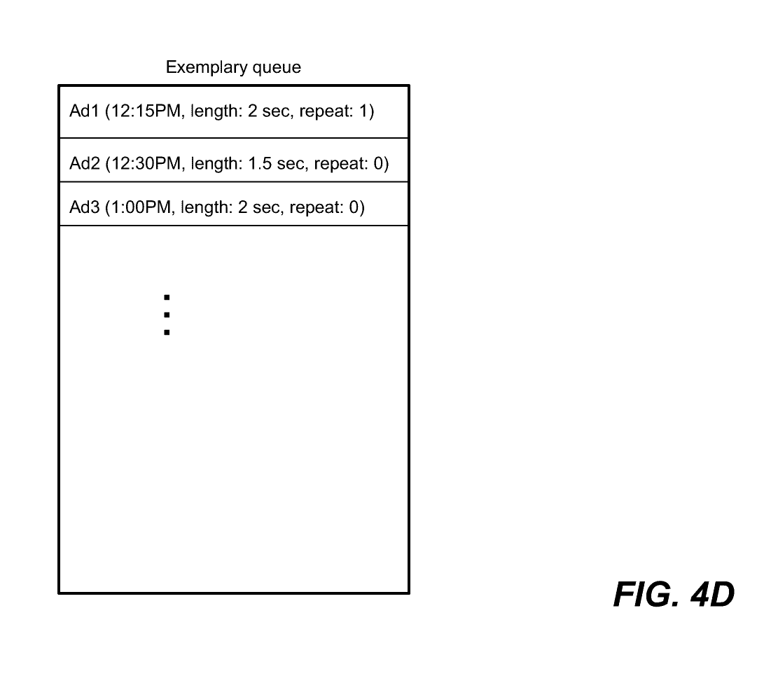

Referring now to FIG. 4A, there is shown a functional block diagram of a server 400 in which a server module 402 resides in a memory space 403 and is executed by one or more processors 401. The server 400 is a representation of many similar servers operated by an ad publisher and may be used in FIG. 1A to facilitate the allocation of ads for each of subscribers or users, arrangements between the advertisers and each of the users, and settlements of payments or points towards the viewing of the ads.

Depending on implementation, this server 400 may be a single server or a cluster of two or more servers. One embodiment of the present invention is implemented as cloud computing in which there are multiple computers or servers deployed to serve as many businesses or individuals as practically possible. For illustration purpose, a single server 400 is shown in FIG. 4. Further, the server 400 includes a network interface 404 to facilitate the communication between the server 400 and other devices on a network, and a storage space 405. In one embodiment, the server module 402 is an executable version of one embodiment of the present invention and delivers, when executed, some or all of the features/results contemplated in the present invention. It should be noted that a general computing device is not able to perform or deliver what the server 400 is equipped to do without the installation of or access to the server module 402.

According to one embodiment, the server module 402 comprises an administration interface 406, an account manager 408, a client (advertiser) manager 410, a security manager 412, an advertisement manager 414, a data processing module 416 and a payment manager 418.

### Administration Interface 406:

As the name suggests, the administration interface 406 facilitates a system administrator to access various components in the server module 402 and set up various parameters of the components. In one embodiment, a publisher uses the administration interface 406 to determine a spread for its profit. For example, an advertiser is willing to pay $0.90 for a user to view an ad. The publisher may extract a fee (e.g., 25%) on the payment from the advertiser, thus the maximum the user can get paid is $0.675 (75%×0.90) for viewing the ad. In another embodiment, the administration interface 406 allows a publisher to manage all subscribing accounts for the advertisers and determine what and how much to charge for servicing the advertisers. In addition, advertisements in digital forms are received from the advertisers and kept in storage 405 or a database 407 via the administration interface 406.

### Account Manager 408:

The account manager 408 is provided to allow a user to automatically register himself with the server 400 for a service being offered by the server 400 or register with a client module running on his mobile device, where the client module is designed to cause his mobile device to communicate with the server 400 via the interface 404. In one example, a user causes the client module to be executed for the first time on his device (e.g., iPhone), the module is designed to request the user to enter certain information (e.g., username/password, a fingerprint, a true name and etc.) before allowing the user to create a profile including an account for receiving payment. In one embodiment, a user is allowed to link his electronic wallet to his account. Whenever there is a payment from an advertiser or the ad publisher, the payment goes to his electronic wallet. After the registration, a profile of the user is created and then transported to the server 400. According to one embodiment, the account manager 408 indicates to the server 400 that a user who has expressed a plan to purchase an item (e.g., a TV or a tablet computer), the server module 402 is designed to take a special care of the user by notifying the advertisers of the purchase intent from the user. Depending on implementation, some advertisers may make a special promotion of the item or items similar to what is in the mind of the user. The promotion may be one or more of a special discount, a voucher, a rebate or other appended services/products. Not only viewing the ad or ads from these advertisers for a competing payment, the user may get additional perks by clicking through all the way to a successful transaction of purchasing an item being advertised.

### Client Manager 410

The client manager 410 is provided to manage versions of client modules provided to the users. In one embodiment, besides keeping updates to the client module, there may be two versions of it, one for paying users for viewing the ads being distributed by the publisher, and the other for non-paying users. The non-paying client module is for distributing ads without compensating viewers for viewing the ads. In comparing to the paying advertisers, the concept of non-paying advertisers is not meant that the advertisers are not paying the publishers for distributing their advertisements, instead is meant for those advertisers preferred not to compete with other advertisers in getting the eyes of the users. Depending on implementation, these two versions of the client module may be implemented as a single module or two separate modules. In the context of the present invention, the client manager 410 controls when to switch from one version to another in accordance with a set of parameters about a user. In operation, the client manager 410 is notified which version or release a registered user is using.

### Security Manage 412

This module is configured to provide security when needed. The stored data for each of the subscribing businesses or registered users may be encrypted, thus only an authorized user may access the secured data. For example, all personal information of the users, especially the accounts set up by the users to receive the payments for viewing the ads are stored securely. In one embodiment, the security manage 412 is configured to initiate a secure communication session with a client device when the user of the client device shall be paid. The secure session allows a payment to be made to the designated account. In addition, the profile and preferences provided by the user are also secured by the security manager 412.

### Advertisement Manager 414

The advertisement manager 414 is a tool provided to allocate one or more advertisements for a user in accordance with his provided profile, where the advertisements are chosen based on certain criteria set by the ad publisher or/and the user. Depending on implementation, the criteria may be based on a profile provided by the user or a profile retrieved from a social network, where the user allows an access to his profile on the social network and shares his interests with others there. In addition, the publisher has also establish the criteria as so a purchase history, a historical browsing habit, possible buying power and other considerations. For example, the advertisement manager 414 would never allocate female cosmetic advertisements to a male user. Likewise the advertisement manager 414 may be designed not to allocate female cosmetic advertisements to a female user if it is detected that the female user has never clicked through a cosmetic advertisement. In operation, the Advertisement manager 414 is designed to periodically or constantly reallocate advertisements for each of the users based on a set of parameters to maximize the delivery and usefulness of the respectively allocated ads.

### Data Processing 416:

This module is configured to perform analytic operations to determine which ad to be shown next after a user has viewed one ad. Given the information provided by a user and the payment range by an advertiser or the publisher, the data processing module 416 determines a set of ads in an order for the user. In operation, the data processing module 416 is designed to be periodically or continuously executed to keep the allocated ads in an order that is believed to be most effective. As shown in FIG. 3B, there may be a few ads from one or more advertisers that are believed suitable for a user, each ad is set for a price for the user. When two or more ads are substantially similar, the order of showing the ads is very important for certain items. A user may click through an ad and complete a transaction with the ad, resulting in subsequent similar ads relatively or completely useless. According to one embodiment, whenever such a transaction happens, the data processing module 416 is designed to calculate a set of parameters that cause the advertisement manager 414 to reallocate some or all of the ads for the user. In one case, the subsequent similar ads are withdrawn or the price for each of the subsequent similar ads is significantly reduced. In another case, the data processing module 416 is designed to calculate a set of parameters that cause the advertisement manager 414 to allocate new ads of items or services that could supplement or expand the use of the purchased item by the user. In the above example of purchasing a smart TV by a user, once the transaction of the purchase is done, further TV ads would be ignored to avoid the waste of money offered by TV manufacturers or TV stores for viewing their TV ads. Instead, it would be much more efficient or useful to send ads related to a cable service or TV accessories or other services (e.g., HDMI cable, surrounding speaker system or extended warranty). In still another case, the user may want to delete an advertiser (perhaps the user has had a bad experience with a product from the advertiser) or add a preferable advertiser (perhaps the user is fascinated with a brand from the advertiser), the data processing module 416 is designed to calculate a set of parameters that cause the advertisement manager 414 to reallocate ads for the user every time there is a change to his profile or an action to a viewed ad. According to another embodiment, certain social network pages (e.g., Facebook) owned by a user are crawled to determine an interest of the user from his interactions with certain applications or visits to certain websites. It is assumed that such access is permitted or opted-in by the user. The retrieved data is analyzed by the data processing module 416 so that the advertisement manager 414 can update or allocate ads for the user.

### Payment Manager 418:

As the name suggests, this module is designed to settle the payment with a user after the user views one or more allocated ads for him. In operation, this module works with the account manager 408 and the data processing unit 416 to ensure that an allocated ad is viewed by the user and the user is compensated for viewing the ad. Should the user has done something extra about the ad, the user is awarded with an extra payment or payments. As described above, when viewing an ad, the user may click it though, result in a transaction from it, forward it to a friend or post it on a whitewall on social network and etc. Each or all of the subsequent actions may get the user some extra payments for viewing the ad. Afterwards, the payment is made electronically by the payment manager 418 to a designated account by the user. In one embodiment, the payment manager 418 settles the payment with an account in a mobile device associated with the user.

Referring now to FIG. 4B, it shows a flowchart or process 430 of forming a queue of ads to be shown to a user. It may be better appreciated in conjunction with the preceding figures and implemented individually or collectively with the processes 300 and/or 350. Depending on implementation, the process 430 may be implemented in software or a combination of software and hardware.

At 432, based on the profile, preferences, and/or analysis of collected data about a user, a set of ads are identified, which means these ads may be of some interest to the user. At 434, a set of parameters are defined for each ad opportunity. As described above, the user has opted in or agreed to accept certain ads to view for payment. In particular, the user may have identified where, when and/or how these ad may appear. Besides, he has the option to activate an application to view some or all of the allocated ads. The user may allow an ad to appear before a selected application is fully launched or a webpage is fully loaded. FIG. 4C shows an example of ad opportunity before an application is fully launched. It is assumed that the user has activated a selected application (e.g., a map application) in display 470. Typically, the map application needs to determine where the user is located currently so his location can be shown in the map when the map is displayed. If the user has newly landed in a place, his mobile device needs to update what is called a map database to reconstruct a map for the new place. If the user has allowed to show an ad before an application is launched or, a display of an ad is shown in display 472. As the underlying events for the map are done, the display 474 shows the map produced by the map application. In any case, this is one of the ad opportunities that can happen a lot on a mobile device every day.

The parameters at 434 define one of such opportunities, including when, where and how an ad will be displayed when such opportunity comes. At 436, the ad publisher sets up an initial fee for queuing an ad for the opportunity and auctions the opportunity among the advertisers of the ads identified at 432. The process 430 now goes to 438 and 440 to determine how many advertisers are interested in the spot. Specifically, at 438, the initial fee may be set too low, thus more than one advertisers hope to place their ads in that opportunity. If that happens, the process 430 goes to 442, where the fee is increased or incremented. At 438, the number of the interested advertisers is checked again. If the number is still greater than one, the process 430 goes on to increase the fee again till there is only one advertiser left. Likewise, at 440, the initial fee may be set too high, thus not a single advertiser wants to pay for opportunity. If that happens, the process 430 goes to 444, where the fee is decreased or decremented. At 440, the process 430 checks again to see if one interested advertiser wants to take this opportunity. If the number is still zero, the process 430 goes on to decrease the fee again till one advertiser takes the opportunity. In the end, either 438 or 440 identifies one advertiser interested in placing an ad in the opportunity.

The process 430 now goes to 446 to register an ad for the opportunity in a queue. In general, there are many ad opportunities a mobile device may present in a daily use. Each of the opportunities may be auctioned similarly. At 448, the process 430 checks to see if any remaining advertisers identified at 432 or any new advertisers have joined. If there are such advertisers, the process 430 goes to 434 to continue the bidding process. If there are no more advertisers, the process 430 goes to 450 to wait for an opportunity to come. FIG. 4D shows an example of lined-up ads for showing when an opportunity presents.

As a search engine, Google (www.google.com) uses a bidding process among a plurality of advertisers for a limited number of advertising places, whenever these is a search inquiry from a user. Based on the payments, ads from winning advertisers are placed accordingly in the advertising places. It shall be noted that there are several significant differences between the bidding process offered by Google and the bidding process in the present invention. First, in Google case, the bidding process takes place when an ad opportunity is happening (per a search inquiry from a user). In the present invention, an opportunity is yet to happen. All advertisers are bidding for an opportunity that waits or scheduled to happen. Next, in Google case, the bidding process takes place when the advertisers have no idea who the user may be, all the advertisers are blindly bidding for an ad opportunity to show an ad to someone no who knows who may be looking at the ad, often resulting in showing an ad to someone with no interest at all. In the present invention, the advertisers know who will be looking at the ads. Based on the profile (e.g., employment or income level), the advertisers may even know if the user can afford, the likely chance their ads may be clicked through or a transaction may eventually happen. Even more, in Google case, an advertiser may have to pay a high price again and again for showing an ad to the same user when the user happens to perform repeatedly similar searches. In the present invention, as described above, when it is detected that the user does not do anything for a few ads in one category, the payout to the user for viewing the remaining ads in the category shall be automatically reduced, which in return could potentially save the advertising costs of these advertisers.

The invention is preferably implemented in software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, the description herein is largely on a user receiving a payment from a publisher or an advertiser for viewing an ad. In different embodiments, various vouchers, rewards, or discounts may be made as part of an incentive for the user to view the ad. Thus the payment described above shall also include other types of incentives for a user to view an ad. Further, the description herein is largely based on viewing an advertisement, those skilled in the art shall appreciate that the description is equally applicable to listening to an ad, an alert or a message. Accordingly, the scope of the present invention is defined by the appended claims rather than the foregoing description of embodiments.

1. A method for rewarding a user for receiving a plurality of advertisements, the method comprising:
allocating the advertisements in a server device in accordance with a profile of the user;
determining by a server module being executed in the server device a set of opportunities as to how, when and where, authorized by the user, to deliver the advertisements to a client device associated with the user, wherein the opportunities are automatically detected by a client module stored and executed in the client device when the user is interacting with the client device, and the user is compensated for viewing or listening to the advertisements;
conducting a bidding process electronically among a plurality of advertisers to determine a slot in a queue of delivering the advertisements selectively to the user on the client device, wherein there is a specified cost to place an advertisement in the slot, the specified cost is set to automatically increment or decrement until there is only one advertiser wining the slot in the queue, the queue is specifically placed with the client device, each of the advertisements in the queue has a pay rate to the user when the user views or listens to the each of the advertisements being presented;
presenting the advertisements in the queue when an opportunity presents on the client device;
monitoring how the user views each of the advertisements; and
updating the profile whenever the server module is notified by the client module that there is an interaction with one of the advertisements by the user.

2. The method as recited in claim 1, further comprising: awarding the user an additional incentive when the user forwards the one of the advertisements to another user who ends up establishing an account with the server device.

3. The method as recited in claim 2, wherein the advertisement in the slot of the queue is personalized for the user, the advertiser is notified when the advertisement in the slot of the queue is used by the user.

4. The method as recited in claim 3, wherein the opportunity is at activation time of an activated application, at wake-up time of an activated application, on a lock-screen of the client device or before an activated application is fully launched.

5. The method as recited in claim 1, wherein the bidding process includes a conditional bidding process to allow an advertiser to place an additional advertisement after a successful transaction by the user with one of the advertisements is done, wherein the additional advertisement supplements or expands the use or consumption of an item being promoted in the one of the advertisements.

6. The method as recited in claim 1, wherein said conducting a bidding process comprises:
auctioning electronically among the advertisers an opportunity to present an advertisement to the user, wherein the opportunity defines when, how and where the advertisement will be presented to the user, the opportunity includes a cost that is adjusted upwards or downwards in said auctioning to ensure there is only one of the providers taking the opportunity.

7. The method as recited in claim 6, wherein the advertisers are notified of the profile of the user and each know a potential of sending the advertisement to the user before getting into the bidding process.

8. The method as recited in claim 1, wherein said presenting the advertisements in the queue comprises:
presenting one of the advertisements reserved for the opportunity when the opportunity is present on the client device, wherein the opportunity is a moment of for the user to view or listen to the one of the advertisements.

9. The method as recited in claim 8, wherein the client device is a mobile device executing a client module configured to present each of the advertisements in the queue when the client device is not communicating with the server device, and to present each of the advertisements from the server according to the queue when the client device is communicating with the server device, and wherein the client module reports to the server device when the each of the advertisements is interacted with.

10. The method as recited in claim 9, further comprising settling a payment electronically with an account associated with the mobile device.

11. A mobile device for rewarding a user for receiving a plurality of advertisements, the mobile device comprising:
a display screen;
a memory space for storing a client module;
a processor, coupled to the memory space, executing the client module to cause the mobile device perform operations of:
receiving the advertisements prepared in a server device in accordance with a profile of the user, wherein the server device executes a server module configured to determine a set of opportunities as to how, when and where to deliver the advertisements in the mobile device associated with the user;
detecting whether one of the opportunities has happened when the user is interacting with the mobile device, wherein the opportunities happen automatically with a software application being executed in the mobile device and detected by the client module, and the user is compensated for viewing or listening to any of the advertisements;
presenting the advertisements in a queue when an opportunity is detected in the mobile device, wherein the queue was specifically formed for the user and via a bidding process among a plurality of advertisers for a slot in the queue, wherein there is a specified cost to place an advertisement in the slot, the specified cost is set to automatically increment or decrement until there is only one advertiser wining the slot in the queue;
monitoring how the user views each of the advertisements in the queue; and
causing the server configured to update the profile whenever there is an interaction with one of the advertisements by the user on the mobile device.

12. The mobile device as recited in claim 11, wherein the operations further comprise: awarding the user an additional incentive when the user forwards one of the advertisements to another user who ends up establishing an account with the server device.

13. The mobile device as recited in claim 12, wherein the advertisement in the slot of the queue is personalized for the user, the advertiser is notified when the advertisement in the slot of the queue is used by the user.

14. The mobile device as recited in claim 12, wherein the opportunity is at activation time of a software application, at wake-up time of a software application, on a lock-screen or before an activated application is fully launched.

15. The mobile device as recited in claim 11, wherein the bidding process includes a conditional bidding process to allow an advertiser to place an additional advertisement after a successful transaction by the user with one of the advertisements, wherein the additional advertisement supplements or expands the use or consumption of an item being promoted in the one of the advertisements.

16. The mobile device as recited in claim 11, wherein the bidding process among advertisers comprises:
auctioning electronically among the advertisers an opportunity to present an advertisement to the user, wherein the opportunity defines when, how and where the advertisement will be presented to the user, the opportunity includes a cost that is adjusted upwards or downwards in said auctioning to ensure there is only one of the providers taking the opportunity.

17. The mobile device as recited in claim 16, wherein the advertisers are notified of the profile of the user and each know a potential of sending the advertisement to the user before getting into the bidding process.

18. The mobile device as recited in claim 11, wherein the operations further comprise:
presenting an advertisement reserved for an opportunity when the opportunity is detected in the mobile device, wherein the opportunity is a moment for the user to view or listen to the advertisement.

19. The mobile device as recited in claim 18, wherein the mobile device is executing a client module configured to present each of the advertisements when the client device is not communicating with the server device and to resent each of the advertisements from the server according to the queue when the client device is communicating with the server device, and wherein the client module reports to the server device when the each of the advertisements is interacted with by the user.

20. The mobile device as recited in claim 19, wherein the operations further comprises settling a payment electronically with an account associated with the mobile device.
